(19) United States
(12) Patent Application Publication
(10) Pub. No.: US 2024/0308563 A1
(43) Pub. Date: Sep. 19, 2024

(54) Motorized Janitor Cart Assembly

(71) Applicant: Ryan Dixson, Los Angeles, CA (US)

(72) Inventor: Ryan Dixson, Los Angeles, CA (US)

(21) Appl. No.: 18/121,994

(22) Filed: Mar. 15, 2023

(51) Int. Cl. B62B 5/00; B62B 3/10

(52) U.S. Cl. CPC B62B 5/0046; B62B 3/106; B62B 5/0053; B62B 5/0069

(57) ABSTRACT

A motorized janitor cart assembly includes a cart that has a platform and a frame extending upwardly from the platform. A bracket is coupled to the frame such that the bracket defines a garbage bag space between the bracket and the frame to accommodate a garbage bag. A pair of front rollers is each rotatably disposed on the cart to roll along a support surface and a pair of rear rollers is rotatably disposed on the cart to roll along a support surface. A motor is in mechanical communication with the pair of rear rollers to rotate the pair of rear rollers when the motor is turned on. A control unit is integrated into the bracket and the control unit is in communication with the motor for turning the motor on and off.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to janitor cart devices and more particularly pertains to a new janitor cart device for automatically transporting a janitor cart along a support surface. The device includes a janitor cart and a motor integrated into the janitor cart which rotates rear wheels of the cart. The device includes a throttle button integrated into a handle of the cart for actuating the motor between a minimum speed and a maximum speed. The device includes a rechargeable battery integrated into the handle and a charge port integrated into the handle for charging the rechargeable battery.

### (2) Description of Related Art Including Information Disclosed Under 37 CFR 1.97 and 1.98

The prior art relates to janitor cart devices including a three wheeled cart that includes a cage with a floor comprising a grate, a pair of drive wheels and a single front wheel. The prior art discloses a self propelled pool cart that is structured specifically to accommodate a battery powered pool vacuum. The prior art discloses a motorized cart that includes a remote control that is attached to the motorized cart with a cable. The prior art discloses a variety of motorized tool boxes. The prior art discloses a motorized appliance cart to facilitate a physically disabled user to move an appliance.

### BRIEF SUMMARY OF THE INVENTION

An embodiment of the disclosure meets the needs presented above by generally comprising a cart that has a platform and a frame extending upwardly from the platform. A bracket is coupled to the frame such that the bracket defines a garbage bag space between the bracket and the frame to accommodate a garbage bag. A pair of front rollers is each rotatably disposed on the cart to roll along a support surface and a pair of rear rollers is rotatably disposed on the cart to roll along a support surface. A motor is in mechanical communication with the pair of rear rollers to rotate the pair of rear rollers when the motor is turned on. A control unit is integrated into the bracket and the control unit is in communication with the motor for turning the motor on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a motorized janitor cart assembly according to an embodiment of the disclosure.

FIG. 2 is a left side view of an embodiment of the disclosure.

FIG. 3 is a back view of an embodiment of the disclosure.

FIG. 4 is a schematic view of an embodiment of the disclosure.

FIG. 5 is a perspective in-use view of an embodiment of the disclosure.

### DETAILED DESCRIPTION OF THE INVENTION

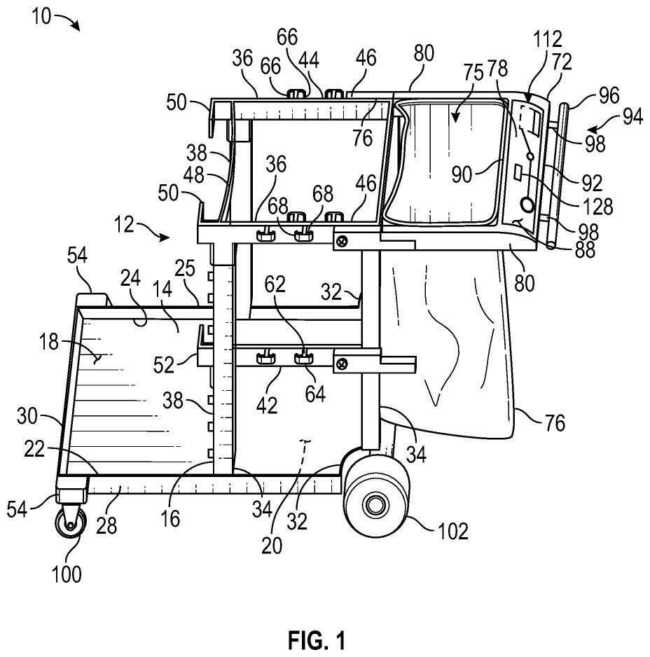

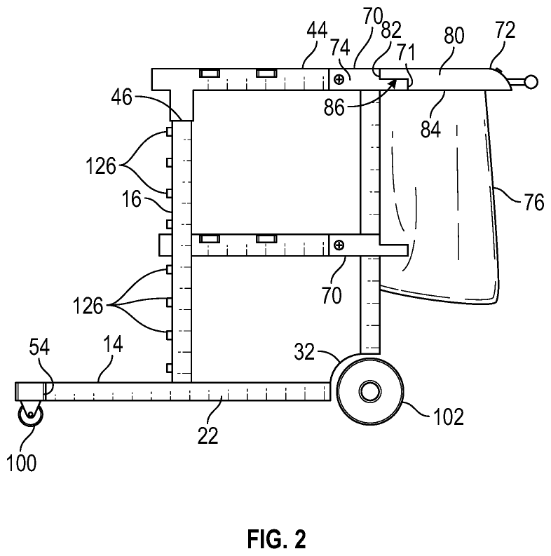

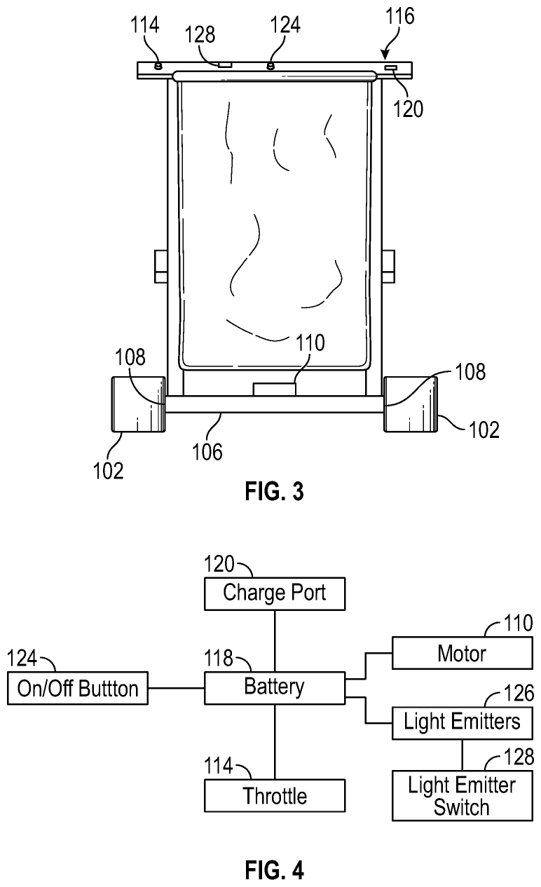

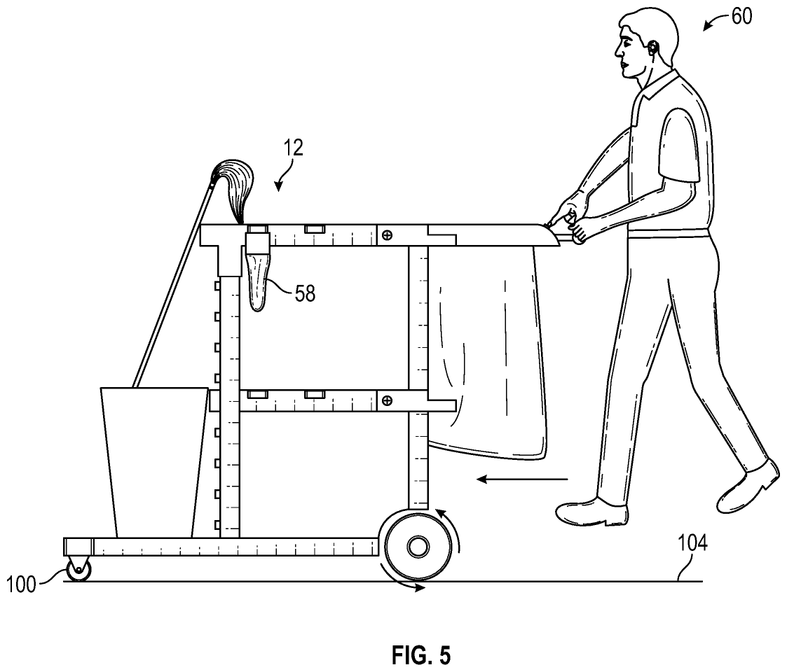

With reference now to the drawings, and in particular to FIGS. 1 through 5 thereof, a new janitor cart device embodying the principles and concepts of an embodiment of the disclosure and generally designated by the reference numeral 10 will be described.

As best illustrated in FIGS. 1 through 5, the motorized janitor cart assembly 10 generally comprises a cart 12 that has a platform 14 and a frame 16 extending upwardly from the platform 14. The platform 14 has a top surface 18, a bottom surface 20 and a lip 22 extending upwardly from the top surface 18; the lip 22 is aligned with and is coextensive with a perimeter edge 24 of the platform 14 and the lip 22 has a first lateral side 25, a second lateral side 26, a back side 28 and a front side 30. The lip 22 has a pair of wheel wells 32 each curves upwardly on a respective one of the first lateral side 25 and the second lateral side 26 and each of the pair of wheel wells 32 is aligned with the back side 28. The frame 16 includes a plurality of vertical members 34 and a plurality of horizontal members 36; the plurality of vertical members 34 includes a set of front members 38 and a set of rear members 40. Each of the front members 38 extends upwardly from the top surface 18 of the platform 14 at a point located between the front side 30 and the back side 28 of the lip 22 on the platform 14 and each of the rear members 40 extends upwardly from a respective one of the wheel wells 32.

The plurality of horizontal members 36 includes a set of bottom support members 42 and a set of top support members 44. The set of top support members 44 is aligned with a top end 46 of the plurality of vertical members 34 and the set of top support members 44 is arranged to define a rectangular shape which extends around the plurality of vertical members 34. The plurality of top support members 44 includes a pair of sidelong members 46 and a front member 48; each of the sidelong members 46 extends beyond the front member 48. Additionally, each of the sidelong members 46 has a foot 50 that is spaced from and is perpendicularly oriented with the front member 48 and the foot 50 on each of the sidelong members 46 is directed toward each other. Each of the bottom support members 42 is positioned between the plurality of top support members 44 and the platform 14 and each of the bottom support members 42 extends beyond the front member 48. Each of the bottom support members 42 has a foot 52 that is spaced from and is perpendicularly oriented with the front member 48 and the foot 52 on each of the bottom support members 42 is directed toward each other.

The platform 14 has a pair of mounts 54 each extending laterally away from the a respective one of the first lateral side 25 and the second lateral side 26 of the lip 22 at a point aligned with a front side 30 of the lip 22. A plurality of hangers 56 is each coupled to the frame 16 and the plurality of hangers 56 is strategically distributed on the frame 16 to support objects 58 for a user 60 to easily access the objects 58. The user 60 may be a janitor, for example, and the objects 58 may be tools and accessories that a janitor will employ to perform their work. Each of the plurality of hangers 56 comprises a stem 62 extending laterally away from the frame 16 and a head 64 that is oriented transverse with the stem 62. The head 64 associated with each of the hangers 56 has a pair of ends 66 and the head 64 associated with each of the hangers 56 has a pair of bends 68 such that each of the ends 66 is directed toward the frame 16. Each of the plurality of hangers 56 is positioned on a respective one of the sidelong members 46 and a respective one of the bottom support members 42.

A plurality of attachment members 70 is provided and each of the attachment members 70 has a leg 71 extending away from a body 74. The body 74 of each of the attachment members 70 has a coupled surface 76 which abuts an outwardly facing surface 78 of a respective one of the sidelong members 46 or an outwardly facing surface 80 of a respective one of the bottom support members 42. Furthermore, the leg 71 of each of the attachment members 70 is directed rearwardly from the respective sidelong member 46 and the respective bottom support member 42. A bracket 72 is coupled to the frame 16 such that the bracket 72 defines a garbage bag space 75 between the bracket 72 and the frame 16 to accommodate a garbage bag 76. The bracket 72 has a central panel 78 extending between a pair of arms 80 and each of the arms 80 is perpendicularly oriented to the central panel 78 such that the bracket 72 defines a U-shape.

Each of the arms 80 has a distal end 82 with respect to the central panel 78 and a lower surface 84 and the lower surface 84 of each of the arms 80 has a cut out 86 extending from the distal end 82 toward the central panel 78. Each of the arms 80 is attached to a respective one of the plurality of attachment members 70 that are attached to the sidelong members 46. Additionally, the cut out 86 associated with each of the arms 80 accommodates the leg 71 associated with a respective one of the attachment members 70 on the sidelong members 46. The distal end 82 of each of the arms 80 abuts the body 74 associated with the respective attachment member 70 on the sidelong member 46 such that the garbage bag space 75 is defined between the central panel 78 and the pair of arms 80. The central panel 78 has a top surface 88 curving downwardly between a front side 90 of the central panel 78 and a back side 92 of the central panel 78.

A handle 94 is attached to the bracket 72 thereby facilitating the handle 94 to be gripped by a user 60. The handle 94 has a rod 96 and a pair of attachments 98 extending between the rod 96 and the back side 28 of the central panel 78 such that the rod 96 extends along a line that is perpendicularly oriented with the back side 28 of the central panel 78 thereby facilitating the rod 96 to be gripped. A pair of front rollers 100 is each rotatably disposed on the cart 12 thereby facilitating each of the front rollers 100 to roll along a support surface 104. Each of the front rollers 100 is pivotally attached to a respective one of the mounts 54 on the lip 22 of the platform 14 having the front rollers 100 extending downwardly from the respective mount 54. Additionally, each of the front rollers 100 is pivotable about a vertical axis extending through the respective mount 54 and each of the front rollers 100 may comprise a caster or the like.

A pair of rear rollers 102 is each rotatably disposed on the cart 12 to roll along a support surface 104. An axle 106 is attached to the platform 14 having the axle 106 extending along the back side 28 of the lip 22 on the platform 14. Each of the rear rollers 102 is rotatably disposed on opposing ends 108 of the axle 106 such that each of the rear rollers 102 is positioned beneath a respective one of the wheel wells 32. A motor 110 is in provided and the motor 110 is in mechanical communication with the pair of rear rollers 102. The motor 110 rotates the pair of rear rollers 102 when the motor 110 is turned on to urge the cart 12 to travel along the support surface 104. The motor 110 is positioned on the platform 14 and the motor 110 is mechanically coupled to the axle 106 such that the motor 110 rotates the axle 106 when the motor 110 is turned on.

A control unit 112 is integrated into the bracket 72 such that the control unit 112 can be manipulated by the user 60. The control unit 112 is in communication with the motor 110 for turning the motor 110 on and off. The control unit 112 comprises a throttle button 114 that is movably integrated into the top surface 88 of the central panel 78 of the bracket 72. The throttle button 114 is electrically coupled to the motor 110 and the throttle button 114 actuates the motor 110 between a minimum speed and a maximum speed which corresponds to a degree to which the throttle button 114 is depressed.

The control unit 112 includes a power supply 116 that is integrated into the central panel 78 of the bracket 72 and the power supply 116 is electrically coupled to the throttle button 114. The power supply 116 comprises a rechargeable battery 118 that is integrated into the central panel 78 of the bracket 72 and the rechargeable battery 118 is electrically coupled to the throttle button 114. The power supply 116 includes a charge port 120 that is recessed into the top surface 88 of the central panel 78 of the bracket 72 thereby facilitating the charge port 120 to receive a charge cord 122. The charge port 120 is electrically coupled to the rechargeable battery 118 for charging the rechargeable battery 118 and the charge port 120 may comprise a universal serial bus port or the like. The power supply 116 includes a power button 124 that is movably integrated into the top surface 88 of the central panel 78 of the bracket 72 and the power button 124 is electrically coupled to the throttle button 114. The power button 124 completes a circuit between the throttle button 114 and the rechargeable battery 118 when the power button 124 is in an on position. Conversely, the power button 124 breaks the circuit between the throttle button 114 and the rechargeable battery 118 when the power button 124 is in an off position.

In use, various janitorial tools and accessories are hung from the plurality of hangers 56 and a garbage bag 76 is suspended in the garbage bag space 75. The throttle button 114 is depressed to a desired degree to actuate the motor 110 to a corresponding speed. In this way the cart 12 can travel along the support surface 104 without requiring the user 60 to manually push the cart 12. Thus, the user 60 can easily transport all of the tools and accessories of janitorial work without having to manually push a cart 12 as is required with non-powered janitor carts. Additionally, a charger is plugged into the charge port 120 for recharging the rechargeable battery 118 as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorized janitor cart assembly for automatically transporting janitorial supplies, said assembly comprising:
a cart having a platform and a frame extending upwardly from said platform;
a plurality of hangers, each of said plurality of hangers being coupled to said frame, said plurality of hangers being strategically distributed on said frame wherein said plurality of hangers is configured to support objects for a user to easily access the objects;
a bracket being coupled to said frame such that said bracket defines a garbage bag space between said bracket and said frame wherein said garbage bag space is configured to accommodate a garbage bag;
a handle being attached to said bracket wherein said handle is configured to be gripped by a user;
a pair of front rollers, each of said front rollers being rotatably disposed on said cart wherein each of said front rollers is configured to roll along a support surface;
a pair of rear rollers, each of said rear rollers being rotatably disposed on said cart wherein each of said rear rollers is configured to roll along a support surface;
a motor being in mechanical communication with said pair of rear rollers, said motor rotating said pair of rear rollers when said motor is turned on wherein said motor is configured to urge said cart to travel along the support surface; and
a control unit being integrated into said bracket wherein said control unit is configured to be manipulated by the user, said control unit being in communication with said motor for turning said motor on and off.

2. The assembly according to claim 1, wherein:
said platform has a top surface, a bottom surface and a lip extending upwardly from said top surface, said lip being aligned with and being coextensive with a perimeter edge of said platform, said lip having a first lateral side and a second lateral side and a back side and a front side, said lip having a pair of wheel wells each curving upwardly on a respective one of said first lateral side and said second lateral side, each of said pair of wheel wells being aligned with said back side;
said frame includes a plurality of vertical members and a plurality of horizontal members, said plurality of vertical members including a set of front members and a set of rear members, each of said front members extending upwardly from said top surface of said platform at a point located between said front side and said back side of said lip on said platform, each of said rear members extending upwardly from a respective one of said wheel wells;
said plurality of horizontal members includes a set of bottom support members and a set of top support members, said set of top support members being aligned with a top end of said plurality of vertical members, said set of top support members being arranged to define a rectangular shape extending around said plurality of vertical members, said plurality of top support members including a pair of sidelong members and a front member;
each of said sidelong members extends beyond said front member, each of said sidelong members having a foot being spaced from and being perpendicularly oriented with said front member, said foot on each of said sidelong members being directed toward each other; and
each of said bottom support members is positioned between said plurality of top support members and said platform, each of said bottom support members extending beyond said front member, each of said bottom support members having a foot being spaced from and being perpendicularly oriented with said front member, said foot on each of said bottom support members being directed toward each other.

3. The assembly according to claim 2, wherein:
said platform has a pair of mounts each extending laterally away from said a respective one of said first lateral side and said second lateral side of said lip at a point aligned with a front side of said lip; and
each of said front rollers is pivotally attached to a respective one of said mounts on said lip of said platform having said front rollers extending downwardly from said respective mount, each of said front rollers being pivotable about a vertical axis extending through said respective mount.

4. The assembly according to claim 2, further comprising a plurality of attachment members, each of said attachment members having a leg extending away from a body, said body of each of said attachment members having a coupled surface abutting an outwardly facing surface of a respective one of said sidelong members or an outwardly facing surface of a respective one of said bottom support members, said leg of each of said attachment members being directed rearwardly from said respective sidelong member and said respective bottom support member.

5. The assembly according to claim 4, wherein:
said bracket has a central panel extending between a pair of arms, each of said arms being perpendicularly oriented to said central panel such that said bracket defines a U-shape, each of said arms having a distal end with respect to said central panel and a lower surface, said lower surface of each of said arms having a cut out extending from said distal end toward said central panel;
each of said arms is attached to a respective one of said plurality of attachment members that are attached to said sidelong members, said cut out associated with each of said arms accommodating said leg associated with a respective one of said attachment members on said sidelong members having said distal end of each of said arms abutting said body associated with said respective attachment member on said sidelong member such that said garbage bag space is defined between said central panel and said pair of arms; and
said central panel has a top surface curving downwardly between a front side of said central panel and a back side of said central panel.

6. The assembly according to claim 5, wherein said handle has a rod and a pair of attachments extending between said rod and said back side of said central panel such that said rod extends along a line being perpendicularly oriented with said back side of said central panel wherein said rod is configured to be gripped.

7. The assembly according to claim 2, further comprising an axle being attached to said platform having said axle extending along said back side of said lip on said platform, each of said rear rollers being rotatably disposed on opposing ends of said axle such that each of said rear rollers is positioned beneath a respective one of said wheel wells.

8. The assembly according to claim 4, wherein:
said assembly includes an axle being attached to said platform;
said motor is positioned on said platform, said motor being mechanically coupled to said axle such that said motor rotates said axle when said motor is turned on; and
said control unit comprises a throttle button being movably integrated into said top surface of said central panel of said bracket, said throttle button being electrically coupled to said motor, said throttle actuating said motor between a minimum speed and a maximum speed which corresponds to a degree to which said throttle button is depressed.

9. The assembly according to claim 8, wherein said control unit includes a power supply being integrated into said central panel of said bracket, said power supply being electrically coupled to said throttle button, said power supply comprising:
a rechargeable battery being integrated into said central panel of said bracket, said rechargeable battery being electrically coupled to said throttle button;
a charge port being recessed into said top surface of said central panel of said bracket thereby facilitating said charge port to receive a charge cord, said charge port being electrically coupled to said rechargeable battery for charging said rechargeable battery; and
a power button being movably integrated into said top surface of said central panel of said bracket, said power button being electrically coupled to said throttle button, said power button completing a circuit between said throttle button and said rechargeable battery when said power button is in an on position, said power button breaking said circuit between said throttle button and said rechargeable battery when said power button is in an off position.

10. A motorized janitor cart assembly for automatically transporting janitorial supplies, said assembly comprising:
a cart having a platform and a frame extending upwardly from said platform, said platform having a top surface, a bottom surface and a lip extending upwardly from said top surface, said lip being aligned with and being coextensive with a perimeter edge of said platform, said lip having a first lateral side and a second lateral side and a back side and a front side, said lip having a pair of wheel wells each curving upwardly on a respective one of said first lateral side and said second lateral side, each of said pair of wheel wells being aligned with said back side, said frame including a plurality of vertical members and a plurality of horizontal members, said plurality of vertical members including a set of front members and a set of rear members, each of said front members extending upwardly from said top surface of said platform at a point located between said front side and said back side of said lip on said platform, each of said rear members extending upwardly from a respective one of said wheel wells, said plurality of horizontal members including a set of bottom support members and a set of top support members, said set of top support members being aligned with a top end of said plurality of vertical members, said set of top support members being arranged to define a rectangular shape extending around said plurality of vertical members, said plurality of top support members including a pair of sidelong members and a front member, each of said sidelong members extending beyond said front member, each of said sidelong members having a foot being spaced from and being perpendicularly oriented with said front member, said foot on each of said sidelong members being directed toward each other, each of said bottom support members being positioned between said plurality of top support members and said platform, each of said bottom support members extending beyond said front member, each of said bottom support members having a foot being spaced from and being perpendicularly oriented with said front member, said foot on each of said bottom support members being directed toward each other, said platform having a pair of mounts each extending laterally away from said a respective one of said first lateral side and said second lateral side of said lip at a point aligned with a front side of said lip;
a plurality of hangers, each of said plurality of hangers being coupled to said frame, said plurality of hangers being strategically distributed on said frame wherein said plurality of hangers is configured to support objects for a user to easily access the objects, each of said plurality of hangers comprising a stem extending laterally away from said frame and a head being oriented transverse with said stem, said head associated with each of said hangers having a pair of ends, said head associated with each of said hangers having a pair of bends such that each of said ends is directed toward said frame, each of said plurality of hangers being positioned on a respective one of said sidelong members and a respective one of said bottom support members;
a plurality of attachment members, each of said attachment members having a leg extending away from a body, said body of each of said attachment members having a coupled surface abutting an outwardly facing surface of a respective one of said sidelong members or an outwardly facing surface of a respective one of said bottom support members, said leg of each of said attachment members being directed rearwardly from said respective sidelong member and said respective bottom support member;
a bracket being coupled to said frame such that said bracket defines a garbage bag space between said bracket and said frame wherein said garbage bag space is configured to accommodate a garbage bag, said bracket having a central panel extending between a pair of arms, each of said arms being perpendicularly oriented to said central panel such that said bracket defines a U-shape, each of said arms having a distal end with respect to said central panel and a lower surface, said lower surface of each of said arms having a cut out extending from said distal end toward said central panel, each of said arms being attached to a respective one of said plurality of attachment members that are attached to said sidelong members, said cut out associated with each of said arms accommodating said leg associated with a respective one of said attachment members on said sidelong members having said distal end of each of said arms abutting said body associated with said respective attachment member on said sidelong member such that said garbage bag space is defined between said central panel and said pair of arms, said central panel having a top surface curving downwardly between a front side of said central panel and a back side of said central panel;
a handle being attached to said bracket wherein said handle is configured to be gripped by a user, said handle having a rod and a pair of attachments extending between said rod and said back side of said central panel such that said rod extends along a line being perpendicularly oriented with said back side of said central panel wherein said rod is configured to be gripped;
a pair of front rollers, each of said front rollers being rotatably disposed on said cart wherein each of said front rollers is configured to roll along a support surface, each of said front rollers being pivotally attached to a respective one of said mounts on said lip of said platform having said front rollers extending downwardly from said respective mount, each of said front rollers being pivotable about a vertical axis extending through said respective mount;
a pair of rear rollers, each of said rear rollers being rotatably disposed on said cart wherein each of said rear rollers is configured to roll along a support surface;
an axle being attached to said platform having said axle extending along said back side of said lip on said platform, each of said rear rollers being rotatably disposed on opposing ends of said axle such that each of said rear rollers is positioned beneath a respective one of said wheel wells;
a motor being in mechanical communication with said pair of rear rollers, said motor rotating said pair of rear rollers when said motor is turned on wherein said motor is configured to urge said cart to travel along the support surface, said motor being positioned on said platform, said motor being mechanically coupled to said axle such that said motor rotates said axle when said motor is turned on; and
a control unit being integrated into said bracket wherein said control unit is configured to be manipulated by the user, said control unit being in communication with said motor for turning said motor on and off, said control unit comprising:
a throttle button being movably integrated into said top surface of said central panel of said bracket, said throttle button being electrically coupled to said motor, said throttle actuating said motor between a minimum speed and a maximum speed which corresponds to a degree to which said throttle button is depressed; and
a power supply being integrated into said central panel of said bracket, said power supply being electrically coupled to said throttle button, said power supply comprising:
a rechargeable battery being integrated into said central panel of said bracket, said rechargeable battery being electrically coupled to said throttle button;
a charge port being recessed into said top surface of said central panel of said bracket thereby facilitating said charge port to receive a charge cord, said charge port being electrically coupled to said rechargeable battery for charging said rechargeable battery; and
a power button being movably integrated into said top surface of said central panel of said bracket, said power button being electrically coupled to said throttle button, said power button completing a circuit between said throttle button and said rechargeable battery when said power button is in an on position, said power button breaking said circuit between said throttle button and said rechargeable battery when said power button is in an off position.
